(19) United States
(12) Patent Application Publication
(10) Pub. No.: US 2025/0140264 A1
(43) Pub. Date: May 1, 2025

(54) CONTROLLING HEAD-MOUNTED DEVICES BY VOICED NASAL CONSONANTS

(71) Applicant: GOOGLE LLC, Mountain View, CA (US)

(72) Inventors: Isaac Allen Fehr, Los Angeles, CA (US); Angela Krone, Waterloo (CA); Dongeek Shin, San Jose, CA (US); Ruofei Du, San Francisco, CA (US)

(21) Appl. No.: 18/996,721

(22) PCT Filed: Jul. 21, 2022
(86) PCT No.: PCT/US2022/074015

§ 371 Date: Jan. 17, 2025

(51) Int. Cl. G10L 17/26; G06F 3/01; G10L 15/22

(52) U.S. Cl. CPC G10L 17/26; G06F 3/011; G10L 15/22; G10L 2015/223

(57) ABSTRACT

A system for controlling a head mounted device (HMD). The system includes a processor of a controller of the HMD connected to an Internal Measurement Unit (IMU) and a memory on which are stored machine-readable instructions that when executed by the processor, cause the processor to: receive Internal Measurement Unit (IMU) data generated in response to vibrations produced by voiced nasal consonant vocalizations produced by an HMD user, analyze the IMU data to determine whether the IMU data corresponds to an HMD control command, and responsive to a determination that the IMU data corresponds to the HMD control command, execute the HMD control command.

### BACKGROUND

Head-Mounted Devices (HMDs) have the capability to show users relevant information in a discreet, low-cost way that phones and other devices currently cannot. However, they lack a standard input method that is intuitive, low-effort, hands-free, and discreet.

### SUMMARY

Voiced nasal consonants may be detected by an inertial measurement unit (IMU) located on an HMD and connected to an HMD controller. The IMU, which is not used to detect any type of voice command, can be used to assist to distinguish voiced nasal consonants (as commands for an HMD) from other sounds (e.g., vocal sounds or vocalizations) made by a user (also can be referred to as an HMD user) or other people around the user. In some implementations, the context in which a voiced nasal consonant is produced by a user can be used to identify a voiced nasal consonant as a command (also can be referred to as an HMD control command). The context (e.g., contextual analysis) can be determined based on predictive input data (e.g., input data from one or more sensors).

At least one general aspect includes a computer-implemented method for controlling a head mounted device (HMD). The computer-implemented method can include receiving, by an HMD controller, inertial measurement unit (IMU) data generated in response to a vibration produced by a voiced nasal consonant produced by an HMD user, analyzing, by the HMD controller, the IMU data to determine whether the IMU data corresponds to an HMD control command; and responsive to a determination that the IMU data corresponds to the HMD control command, sending an instruction corresponding with the HMD control command. This general aspect can include any combination of the following features.

The computer implemented method can include analyzing the IMU data further comprising comparing feature embeddings from a IMU spectrogram representing the IMU data with a class prototype of IMU feature embeddings, the class prototype of IMU feature embeddings being produced based on pre-recorded IMU data for the HMD user.

The computer implemented method can include receiving audio data from an audio sensor connected to the HMD controller, the audio data including the voiced nasal consonant corresponding to the IMU data.

The computer implemented method can include performing analysis of the audio data to confirm that the voiced nasal consonant corresponds to the HMD control command.

The computer implemented method can include providing the audio data to a machine learning module executing an audio data ML model for recognition of the voiced nasal consonant.

The computer implemented method can include providing the IMU data to a machine learning module executing an IMU data ML model to make the determination that the voiced nasal consonant corresponds to the HMD control command.

The computer implemented method can include extracting feature embeddings from an IMU spectrogram representing the IMU data, classifying the feature embeddings from the IMU spectrogram using an IMU classifier as a class prototype of IMU feature embeddings, and determining the HMD control command based on the class prototype of the IMU feature embeddings.

The computer implemented method, wherein the class prototype of the IMU feature embedding corresponds with the voiced nasal consonant.

The computer implemented method, wherein the classifying includes calculating a confidence level.

The computer implemented method can include, wherein the classifying includes calculating prediction data.

The computer implemented method can include combining the IMU data with predictive input data including user eye-gaze data.

The computer implemented method can include combining the IMU data with predictive input data comprising detection of a touch input on a frame of the HMD.

The computer implemented method can include combining the IMU data with predictive input data including a user movement.

The computer implemented method can include combining the IMU data with predictive input data including image sensor data.

In another general aspect a system for controlling a head mounted device (HMD) can include a processor of an HMD controller connected to an inertial measurement unit (IMU); and a memory on which are stored machine-readable instructions that when executed by the processor, cause the processor to receive Internal Measurement Unit (IMU) data generated in response to a vibration produced by a voiced nasal consonant produced by an HMD user, analyze the IMU data to determine whether the IMU data corresponds to an HMD control command, and responsive to a determination that the IMU data corresponds to the HMD control command, sending an instruction corresponding with the HMD control command. Tis general aspect can include any combination of the following features.

The system wherein the machine-readable instructions further cause the processor to compare the IMU data with stored IMU data pre-recorded for the HMD user.

The system wherein the machine-readable instructions further cause the processor to receive audio data from an audio sensor connected to the HMD controller, the audio data including the voiced nasal consonant corresponding to the IMU data.

The system wherein the machine-readable instructions further cause the processor to perform contextual analysis of the audio data to confirm that the voiced nasal consonant corresponds to the HMD control command.

The system wherein the machine-readable instructions further cause the processor to provide the audio data to a machine learning module executing an audio data model for recognition of the voiced nasal consonant.

The system wherein the machine-readable instructions further cause the processor to provide the IMU data to a machine learning module executing an IMU data model to make the determination that the voiced nasal consonant corresponds to the HMD control command.

In another general aspect, a non-transitory computer-readable medium storing instructions that, when executed by a processor of cause the processor to perform a method comprising receiving inertial measurement unit (IMU) data generated in response to a vibration produced by a voiced nasal consonant produced by an HMD user, analyzing the IMU data to determine whether the IMU data corresponds to an HMD control command, and responsive to a determination that the IMU data corresponds to the HMD control command, sending an instruction corresponding with the HMD control command. This general aspect can include any combination of the following features.

The non-transitory computer-readable medium can include comparing the IMU data with stored IMU data pre-recorded for the HMD user.

The non-transitory computer-readable medium can include providing the IMU data to a machine learning module executing an IMU data model to make the determination that the voiced nasal consonant corresponds to the HMD control command.

### BRIEF DESCRIPTION OF THE DRAWINGS

FIG. 1 illustrates a diagram of an example process of micro-voice gesture recognition for control of an HMD, in accordance with the disclosed implementations.

FIG. 2A is a diagram that illustrates a machine learning (ML) module configured to process IMU data and predictive input data.

FIG. 2B is a diagram that illustrates another example of a ML module configured to process IMU data and predictive input data.

FIG. 2C illustrates a diagram for processing a combination of low-level spectrograms of micro-voice gestures, in accordance with the disclosed implementations.

FIG. 2D illustrates an example spectrogram.

FIG. 2E is a diagram that illustrates production of a set of class prototypes of IMU feature embeddings using a pre-trained IMU ML model.

FIG. 2F is a diagram that illustrates a nearest neighbor IMU classifier configured to classify candidate IMU feature embeddings.

FIG. 3 illustrates an example network including an HMD controlled by the micro-voice gestures, in accordance with the disclosed implementations.

FIG. 4 illustrates an example system for micro-voice gesture recognition including a detailed description of an HMD controller, in accordance with the disclosed implementations.

FIG. 5 is a diagram that illustrates control of a peripheral device according to an implementation.

FIG. 6 is a flowchart of an example method for micro-voice gesture recognition, in accordance with the disclosed implementations.

FIG. 7 is a further flowchart of the example method, in accordance with implementations described herein.

FIG. 8 shows an example of a generic computer device and a generic mobile computer device.

### DETAILED DESCRIPTION

This disclosure relates to systems and methods for controlling a head mounted device (HMD) using voiced nasal consonants (e.g., syllabic voiced nasal consonants (e.g., a voiced nasal consonant identified as a single syllable), “Nuh-uh” is a voice gesture or non-word vocalization composed of two nasal consonant syllables: 1) nnn and 2) NNN). The HMD can be configured to provide, for example, virtual objects projected within the HMD to augment the real-world environment within a physical space. In other words, the HMD can be configured to provide an augmented reality (AR) and/or mixed reality (MR) experience for a wearer of the HMD.

While an HMD can be controlled by a voice input, many people feel uncomfortable speaking aloud to and/or otherwise controlling a wearable device in public. In addition, if used in a public place in close proximity with (e.g., within range of a microphone of the HMD) other people, the voices of the other people may inadvertently affect the functionality of an HMD (e.g., inadvertently speak a command that may be registered by the HMD). Similarly, touching or controlling using touch, a portion of an HMD to control the HMD may not be desirable in some situations. For example, tapping on a portion (e.g., a side) of an HMD while engaged in a conversation or during a meeting may be disruptive. These situations can significantly limit the utility of a wearable device such as an HMD.

To solve at least the technical problems described above, a system and method for controlling head-mounted devices (HMDs) by micro-voice gestures, including voiced nasal consonants, have been developed and are described herein. The micro-voice gestures can include voice gestures that are not necessarily nasal. In some implementations, the voiced nasal consonants are non-word sounds.

Detection and processing of the voiced nasal consonants provide for an intuitive and low-effort input method for controlling an HMD. Users can control the HMD using voiced nasal consonants such as “Mm-hm”, “Nuh-uh”, and “Hmm?” (phonetically “mmm-MMM”, “NNN-nnn”, and “mmMM” respectively). Through this voice nasal consonants, control of the HMDs may be implemented completely hands-free by using sounds that may naturally be made by a user multiple times in the course of a day. Voiced nasal consonants (“mmm” and “nnn”) can be vocalized by the user in a discreet manner even when the mouth is closed, and done so quietly, making it difficult for bystanders to detect sounds from the user in environments with medium to high ambient sound.

In at least one implementation, an input method for controlling HMDs may allow for detection of subtle vocalization fragments such as voiced nasal consonants present within the vocalizations such as “mmm-MMM”, “NNN-nnn”, and “mmMM.” The detected voiced nasal consonants may be mapped to control commands (also can be referred to as HMD control commands) corresponding to on-device actions such as select, back, wake, etc.

In order to be discreet, the selected vocalization interaction set can be performed quietly and without opening the mouth. In phonetics, these properties belong to a set of phonemes referred to as Nasal Consonants: [n], [η] and [m].

In at least one implementation, voiced nasal consonants may be detected by an Inertial Measurement Unit (IMU) located on an HMD and connected to an HMD controller. The IMU, which is not used to detect any type of voice command, can be used to assist to distinguish voiced nasal consonants (as commands for an HMD) from other sounds (e.g., vocal sounds or vocalizations) made by a user (also can be referred to as an HMD user) or other people around the user. The IMU can be used to detect very low-frequency vibrations (e.g., less than 1500 Hertz (Hz)) caused by the voiced nasal consonants. For better detection of very low-frequency vibrations, the IMU may be positioned or integrated at a proximate end of a frame of the HMD (i.e., close to a user's temple) where vibrations may be magnified by the frame. The vibrations are, to some extent, self-isolating. In other words, the vibrations are produced by the wearer (or user) of the HMD and can be isolated from the ambient noise, which will not result in vibrations within the HMD.

In some implementations, the context in which a voiced nasal consonants is produced by a user can be used to identify the voiced nasal consonant as a command (also can be referred to as an HMD control command). The context (e.g., contextual analysis) can be determined based on predictive input data (e.g., input data from one or more sensors). For example, if a prompt (e.g., a user interface prompt) in the HMD is produced for viewing by a user, and the user responds with a voiced nasal consonant within a threshold period of time (e.g., within a few seconds) from the prompt, the voiced nasal consonant can be identified (e.g., interpreted) as a command. The context of the prompt can be used to identify the voiced nasal consonant as a command. As another example, a voiced nasal consonant that is disconnected from a user interface prompt (e.g., separated by more than a threshold period of time (e.g., more than 10 seconds)) may not be interpreted as a command.

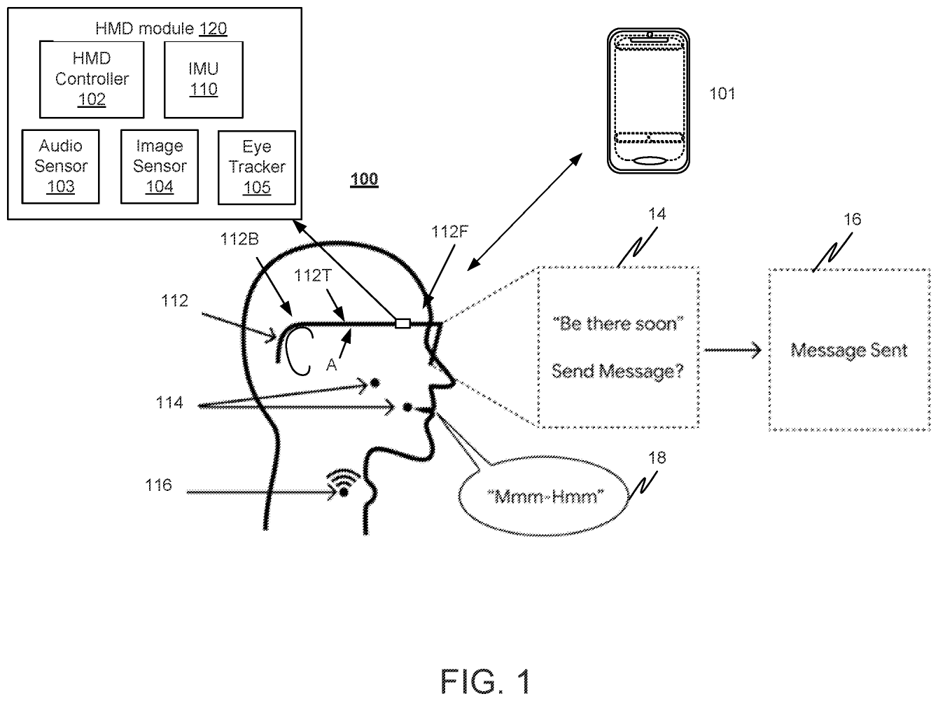

FIG. 1 illustrates a diagram 100 of an example process of micro-voice gesture (e.g., voiced nasal consonant) recognition (e.g., identification) for control of an HMD 112, in accordance with the disclosed implementations. In this example, a user wears an HMD 112 in the form of smart glasses.

As discussed above, a user may produce voiced nasal consonants (also can be referred to as nasal occlusives or as voiced nasal consonants) to control the HMD 112. In some implementations, the voiced nasal consonants produce a phoneme while a user's oral track (mouth) is completely closed, forcing air through the nose. Lips or alveolar 114 may articulate phonemes [m] and [n] respectively. If the user chooses to use the voiced nasal consonants, this means the vocal cords 116 are vibrating—i.e., producing very low-frequency sound waves below 1500 Hz. Because these phonemes produce clear low-frequency sounds (i.e., vibrations) that can be transmitted (e.g., travel well) through the user's head and onto the frame of the HMD 112, the vibrations can be detected by an Internal Measurement Unit (IMU) 110 connected to an HMD controller 102 integrated within (e.g., inside of) a frame of the HMD 112. The IMU 110 and HMD controller 102 can be part of an HMD module 120.

In contrast to the voiced nasal consonants, typical voice vocalizations (e.g., spoken words) have a high-frequency of 15 kHz for most users, which may not be accurately detected (or detected at all) by the IMU 110. Accordingly, typical voice vocalizations can be distinguished from voiced nasal consonants using the IMU 110.

As noted above, the phonemes are syllabic, which can mean they produce syllables without any other phonemes (e.g., “mmm” as opposed to “ma”, “em”, etc.). Note that [m] and [n] are low-frequency vocalized phonemes that vibrate in a way that can be effectively detectable by the IMU 110.

In this example, the user may produce a voiced nasal consonant 18 that is detected by the IMU 110. In this implementation, the IMU data is provided to the HMD controller 102, which processes this data to determine a corresponding HMD command 18 that causes the HMD 112 to send a message as confirmed in user interface confirmation 16 after a user interface prompt 14. In this example, the voiced nasal consonant 18, when produced after the user interface prompt 14 with a query to “Send Message?”, the message “Be there soon” is sent as illustrated in user interface confirmation 16. In this example, the user interface prompt 14 and the user interface confirmation 16 can both be user interface elements that are displayed within a display (not shown) of the HMD 112.

In some implementations, one or more voiced nasal consonants such as the voiced nasal consonant 18 can be used as a set of control commands to navigate an HMD user interface (e.g., a displayed HMD user interface) of the HMD 112.

According to the disclosed implementations, various associated voiced nasal consonants can be used to control the HMD 112. Many types of controls (e.g., HMD control commands) can be implemented within an HMD 112 using voiced nasal consonants

For example, “Hmm?” can be used to wake a display of the HMD 112. The voiced nasal consonant of “Hmm?” can be used as a command based on the context of the HMD 112 not being used for a period of time (e.g., a few minutes).

In some implementations, “Hmm?” can be used to start contextual sensing. In some implementations, “Hmm?” can be used to see more information within a user interface (e.g., a notification within a user interface).

As another example, “Mm-hm” can be used to select an affirmative option (e.g., a yes/no interaction to answer a call, open a notification, etc.). The voiced nasal consonant “Nuh-uh” can be used to select a negative option (e.g., a yes/no interaction to decline a call, clear a notification, etc.).

In some implementations, “Nuh-uh” can be used to clear a notification. The context of the presence of a notification can be used to determine that clearing the notification is the command triggered by “Nuh-uh”.

In some implementations, “Nuh-uh” can be used to go back within an HMD UI. The context of multiple UI elements being presented in succession can cause the voiced nasal consonant “Nuh-uh” to trigger the go back command.

In some implementations, “Nuh-uh” can be used to cause the display to sleep. In some implementations, the context of no user interface and/or interaction for a threshold period of time can cause the display to sleep in response to “Nuh-uh.”

In some implementations, “Mm-hm” can be used to activate an HMD UI element targeted with eye tracking. The context of certain eye tracked movement can result the command being detected and implemented.

In order to be discreet, the selected vocalization interaction of voiced nasal consonants can be performed by the user quietly and without opening the mouth.

As discussed above with respect to FIG. 1, micro-voice gestures produced by voiced nasal consonants may be detected (at least in part in some implementations) by the IMU 110 of the HMD 112 such as smart glasses. At least one advantage of using of the IMU 110 for detection of the voiced nasal consonants is related to distinction of typical vocalization, such as spoken words or normal speech, from voiced nasal consonants. For voiced nasal consonants, the in-air volume is much lower than the volume of a normal speech. Picking up through-body vibrational cues by the IMU 110 provides for a better signal-to-noise (STN) ratio. As discussed above, the IMU 110 may detect low-frequency vibrations below approximately 1500 Hz produced by the voiced nasal consonants and the IMU 110 may not detect other voice vocalizations (i.e., high-frequency vibrations of up to 15 kHz range produce by a normal voice). Thus, the STN ratio detection of voiced nasal consonants using the IMU 110 may be much higher compared to normal voice command detection.

Since the voiced nasal consonants are specifically used for user inputs for the HMD 112, the user inputs trigger (e.g., only trigger) actions from the micro-voice gestures coming from the HMD user, and not from people around the HMD user. Relying on the IMU 110 breaks the speaker ambiguity that microphone-only solutions may face. In other words, instead of using ambiguous words or phrases, the HMD user may just produce very low sounds that nearby people may not hear or understand. Specifically, the IMU 110 is not capable of detecting sounds, including voiced nasal consonants, produced by other people because the detection mode of the IMU 110 (and voiced nasal consonants) is vibrational in nature.

In some implementations, one or more sensors shown as audio sensor 103, image sensor 104, eye tracker 105 in FIG. 1 are used to produce predictive input data (e.g., audio data, image data, eye tracking data) can be used by the HMD 112 and/or a companion device 101 (e.g., a mobile phone) connected (e.g., communicably connected) to the HMD 112 to identify and use voiced nasal consonants. Using one or more voiced nasal consonants can include interpreting the one or more voiced nasal consonants as one or more HMD control commands to control the HMD 112 and/or the companion device 101.

In some implementations, the processing (or portion thereof) of predictive input data can be performed at the HMD module 120 within the HMD 112 and/or at the companion device 101. In some implementations, the predictive input data is sent from the HMD 112 as raw data that is processed at the companion device 101 because the computing resources (e.g., processing power, battery life) at the HMD 112 may be more limited than at the companion device 101. In other words, predictive input data HMD control commands can be produced at the HMD 112 and sent to the companion device 101 where the HMD control commands are used to control one or more applications executing on the companion device 101. In some implementations, HMD control commands can be produced at the HMD 112 and sent to the companion device 101 where the HMD control commands are used to control one or more applications executing on the companion device 101.

In some implementations, one or more microphones (e.g., a single microphone, an integrated microphone array) can be used in combination with the IMU 110 for increased accuracy of detection of one or more voiced nasal consonants. The one or more microphones can be represented as the audio sensor 103 of the HMD module 120. The one or more microphones can be used to identify context.

For example, the IMU 110 can be used to detect vibrations associated with a voiced nasal consonant. The candidate vibrations can be initially identified as voiced nasal consonants and the audio sensor 103 can be used to detect sounds concurrently with (e.g., simultaneous with, during a same timeframe with, within a time window with) the candidate vibrations to confirm that the candidate vibrations are voiced nasal consonants. In some implementations, vibrations from an IMU 110 can be confirmed as a voiced nasal consonant, using the techniques described herein, without using audio from an audio sensor 103.

In some implementations, one or more image sensors (e.g., a single image sensor, an infrared sensor, an outward facing image sensor) can be used in combination with the IMU 110 for increased accuracy of detection of one or more voiced nasal consonants. The one or more sensors can be represented as the image sensor 104 of the HMD module 120. The one or more image sensors can be used to identify context.

For example, the IMU 110 can be used to detect vibrations associated with a voiced nasal consonant. The candidate vibrations can be initially identified as voiced nasal consonants and the image sensor 104 can be used to detect images captured concurrently with (e.g., simultaneous with, during a same timeframe with, within a time window with) the candidate vibrations to confirm that the candidate vibrations are voiced nasal consonants.

In some implementations, one or more microphones (e.g., audio sensor 103), one or more image sensors (e.g., image sensor 104), and/or one or more eye trackers (e.g., eye tracker 105) can be used in combination with the IMU 110 for increased accuracy of detection of one or more voiced nasal consonants. The one or more microphones and one or more image sensors can be used to identify context.

For example, the IMU 110 can be used to detect vibrations associated with a voiced nasal consonant. The candidate vibrations can be initially identified as voiced nasal consonants and the audio sensor 103 and the image sensor 104 can be used to detect sounds and images, respectively, captured concurrently with (e.g., simultaneous with, during a same timeframe or time window) the candidate vibrations to confirm that the candidate vibrations are voiced nasal consonants. The eye tracker 105 can be used to determine that a user is viewing a prompt (e.g., a user interface prompt) displayed on a display of the HMD 112 (e.g., a display projected onto a lens of the HMD 112) (not shown). Accordingly, the voiced nasal consonant can be interpreted as an HMD control command (e.g., a selection, a deletion, a confirmation, a negative response) associated with the prompt.

In some implementations, a vibration associated with a voiced nasal consonant can function as a selection method (e.g., akin to a mouse click) that does not correspond with a prompt within a user interface. In other words, a vibration associated with a voiced nasal consonant can function as a selection method (e.g., akin to a mouse click) that does not correspond with a vocalization for a word within a user interface. Accordingly, the voiced nasal consonant can replace a typical word as an input selection method.

For example, a user interface can include a prompt with the words “yes” or “no” displayed within the user interface. A voiced nasal consonant such as “Mm-hm” can be used to select “yes” and a voiced nasal consonant of “Nuh-uh” can be used to select “no.” Accordingly, the sounds and/or vibrations used to select one of the input options associated with the yes/no user interface will not correspond with the words “yes” or “no.”

In some implementations, the IMU 110 (and/or HMD module 120) can be disposed in a front portion of the HMD 112 so that vibrations are propagated in a desirable fashion to the IMU 110. The front portion 112F of the HMD 112 can be a portion of the HMD 112 including one or more lenses of the HMD 112 and near the eyes and nose of the user. A back portion 112B of the HMD 112 can be a portion of the HMD 112 near or around an ear of the user.

In some implementations, the IMU 110 (and/or HMD module 120) can be disposed in a front portion 112F of the HMD 112 so that vibrations are amplified in a desirable fashion to the IMU 110. Specifically, vibrations induced in a temple arm 112T (around and/or above an ear (not shown) of a user (e.g., location A)) can be propagated toward the front portion 112F of the HMD 112. Vibrations toward the front portion 112F of the HMD 112 (where the temple arm 112T is not in contact with a head of the user) can be greater than vibrations along the temple arm 112T that is in contact with a head of the user.

In some implementations, 3-channel (e.g., X, Y, and Z data) IMU data from the IMU 110 is used without gyroscopic data. The low frequency 3-channel information is uniquely being used from vibrations associated with voiced nasal consonants as HMD control commands. In some implementations, less than 3 channels of IMU data are being used.

In some implementations, the audio sensor 103 can include a directional microphone. In some implementations, the audio sensor 103 may not include an omni-directional microphone.

Although not shown explicitly in the figures any of the data (e.g., IMU data, predictive input data) can be stored in and accessed from a memory. For example, any of the data (e.g., IMU data, predictive input data) can be stored in and accessed from a memory included in the HMD module 120, the companion device 101, and/or in another location that can be accessed (e.g., accessed for processing) by the HMD module 120 and/or the companion device 101.

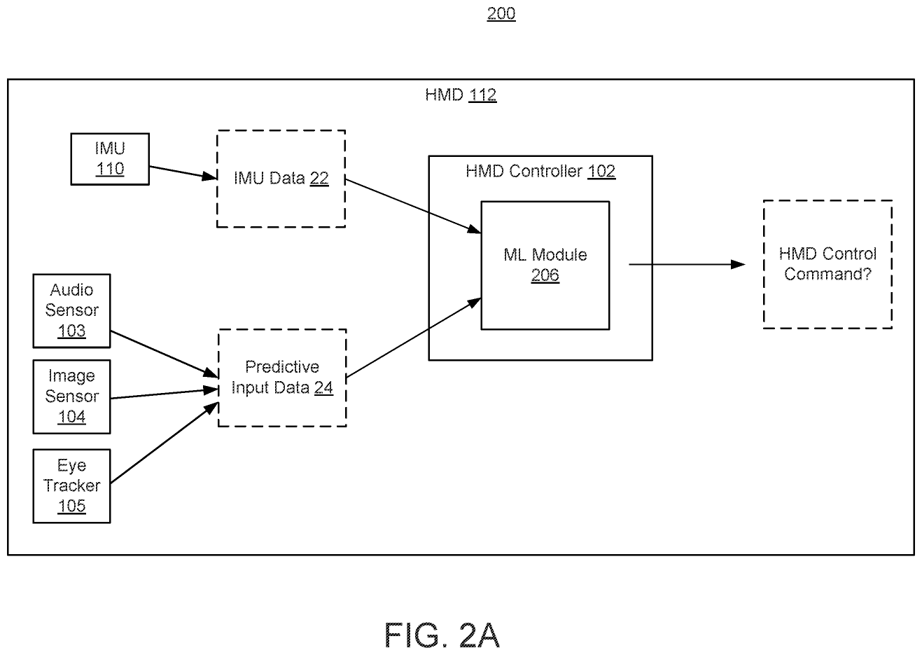

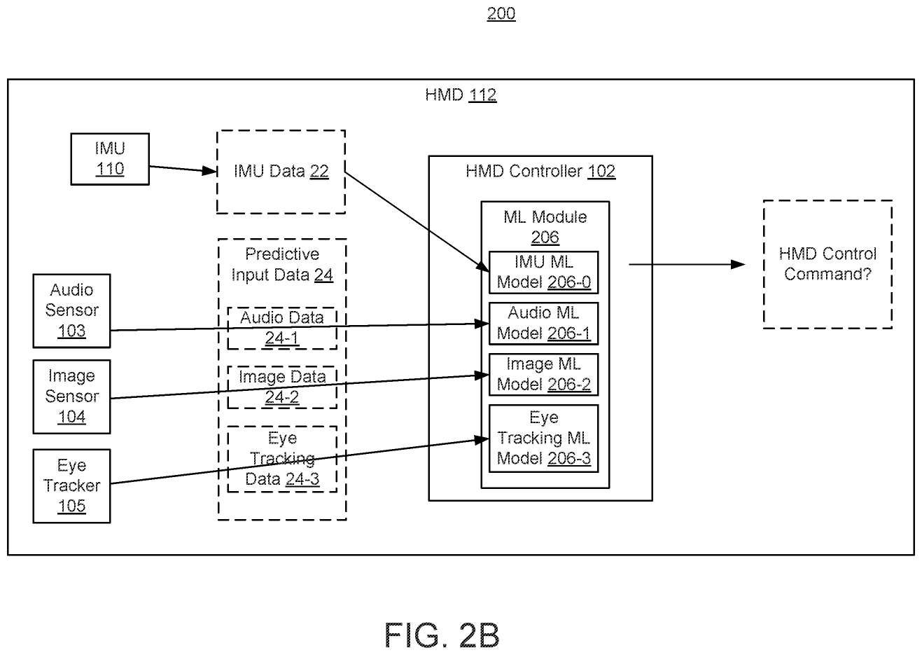

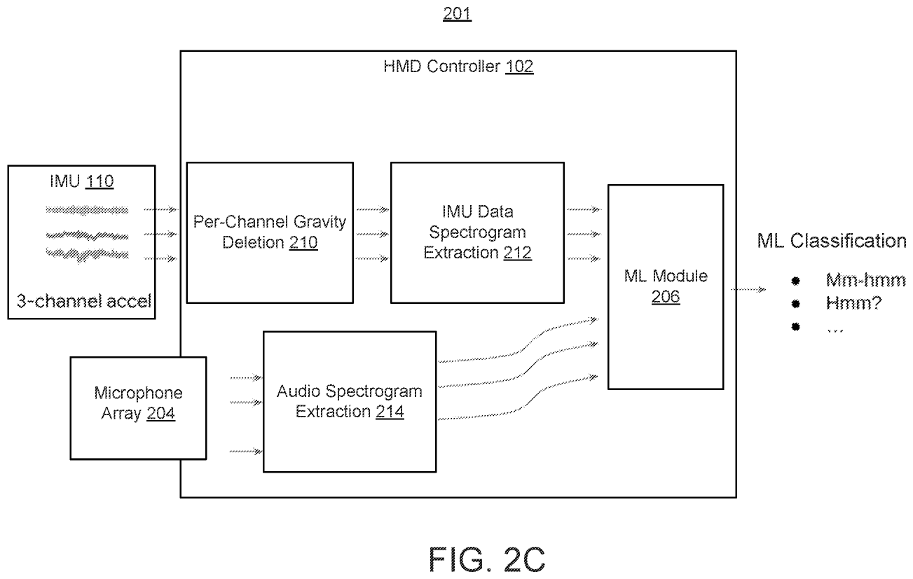

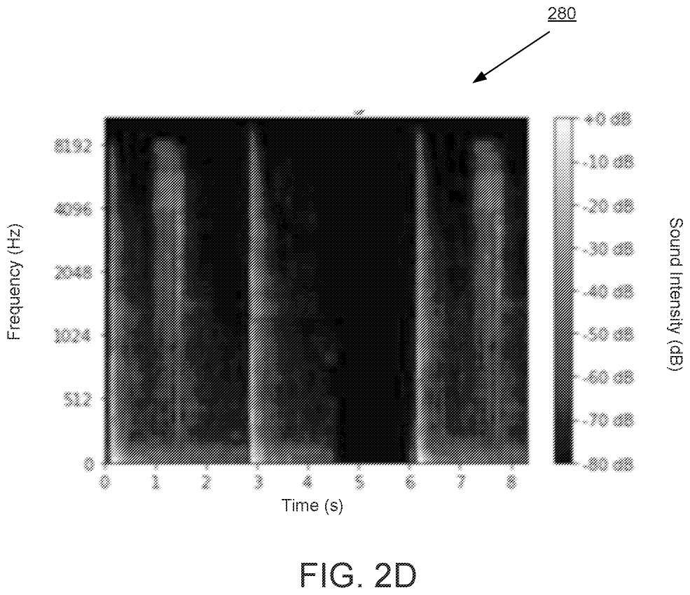

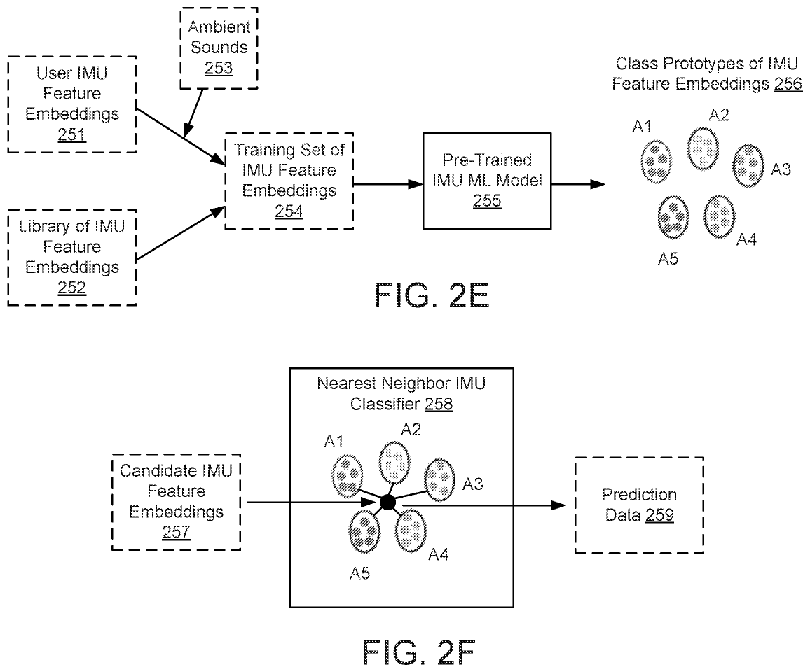

FIG. 2A is a diagram 200 that illustrates an HMD 112 including a machine learning (ML) module 206 within an HMD controller 102 configured to process IMU data 22 (as described above) and predictive input data 24 (e.g., audio data from a microphone (e.g., audio sensor 103), image data from an image sensor (e.g., image sensor 104), eye tracking data from an eye tracker (e.g., eye tracker 105)) to determine whether a vibration associated with a voiced nasal consonant is or is not an HMD control command. In some implementations, the predictive input data 24 can be used to filter out (e.g., exclude) a vibration associated with a voiced nasal consonant as not being an HMD control command. In some implementations, a set of rules (instead of a ML module 206) may be used to confirm a vibration associated with a voiced nasal consonant is or is not an HMD control command. Several examples using predictive input data 24 in conjunction with IMU data 22 are set forth below. Any of the example scenarios below can be combined. In some implementations, the predictive input data 24 can be used to define a confidence level that a vibration associated with a voiced nasal consonant as being or not being an HMD control command.

In some implementations, the ML model (or models) executed within the ML module 206 can be any type of ML model or classifier. One such example is described in connection with FIGS. 2E and 2F.

As an example, a voiced nasal consonant between or near one or more vocalizations can be used to confirm the voiced nasal consonant as an HMD control command. For example, a vocalization by a user (e.g., a wearer of an HMD) can be detected via a microphone (e.g., audio sensor 103 shown in FIG. 1) before a vibration (e.g., within a threshold period of time before the vibration) or after a vibration (e.g., within a threshold period of time after the vibration). In other words, the vibration can be accompanied by a sound associated with the vocalization produced by the user that can be used to determine the vibration is a voiced nasal consonant. The context, or content, of the vocalization can be used to confirm that the voiced nasal consonant is or is not an HMD control command.

As a specific example, a vocalized sentence providing an instruction to the HMD can be detected. A vibration associated with a voiced nasal consonant associated with (e.g., directly after the vocalized sentence) can be used to determine that the vibration is an HMD control command. In some implementations, vibrations (detected by the IMU 110) alone can be used to determine a voiced nasal consonant without external sound detection using the audio sensor 103.

As another example, a voiced nasal consonant between a pair of vocalizations can be used to confirm the voiced nasal consonant as an HMD control command. For example, a vocalization by a person (separate from the user wearing an HMD) can be detected via a microphone (e.g., audio sensor 103 shown in FIG. 1) before a vibration (e.g., within a threshold period of time before the vibration) and after a vibration (e.g., within a threshold period of time after the vibration). The context, or content, of the vocalization produced by the person (separate from the user wearing an HMD) can be used to confirm that the voiced nasal consonant by the user is or is not an HMD control command. In some implementations, the vibration can be accompanied by another sound, produced by the user wearing the HMD, that can be further used to determine whether the vibration is a voiced nasal consonant.

As a specific example, a vocalized sentence detected from a person (separate from the user wearing an HMD) speaking to the user can be detected. A vibration associated with a voiced nasal consonant associated with (e.g., directly after the vocalized sentence) can be used to determine that the vibration is not an HMD control command, but is instead a communication directed to the person speaking to the user. In some implementations, when a conversation is detected with a person (separate from the user wearing an HMD) using, for example, a microphone, a voiced nasal consonant associated with (e.g., directly after the vocalized sentence) can be used to determine that the vibration is not an HMD control command, but is instead a communication directed to the person speaking to the user. The voiced nasal consonants, in these situations, can be interpreted as gestures during active listening and not an HMD control command.

As yet another example, a voiced nasal consonant during a vocalization can be used to confirm the voiced nasal consonant as an HMD control command. For example, a vocalization by a user can be detected via a microphone (e.g., audio sensor 103 shown in FIG. 1) during a vibration. In other words, the vibration can be accompanied by a concurrent sound, produced by the user wearing the HMD, that can be used to determine whether the vibration is a voiced nasal consonant. The context, or content, of the vocalization by the user can be used to confirm that the voiced nasal consonant by the user is or is not an HMD control command.

As a specific example, a sound of a user, such as a “Mm-hm” or “Nuh-uh”, can be used to confirm that a vibration associated with a syllabic voice nasal consonant is an HMD control command.

As yet another example, a voiced nasal consonant and an image (or set of images) captured during or during a timeframe of detection of the voiced nasal consonant can be used to confirm the voiced nasal consonant as an HMD control command. For example, an image (or set of images) of a person (separate from the user wearing an HMD) can be detected via an image sensor (e.g., image sensor 104 shown in FIG. 1) before a vibration (e.g., within a threshold period of time before the vibration), after a vibration (e.g., within a threshold period of time before the vibration), or during a vibration. The context, or content, of the image of the person (separate from the user wearing an HMD) can be used to confirm that the voiced nasal consonant by the user is or is not an HMD control command. In some implementations, the vibration can be accompanied by a sound, produced by the user wearing the HMD, that can be further (in addition to the image(s)) used to determine whether the vibration is a voiced nasal consonant.

As a specific example, an image (or series of images) of a person speaking (e.g., facing toward and speaking) to the user can be used to determine that a vibration associated with a syllabic voice nasal consonant is not an HMD control command, and is instead a communication directed to the person. In some implementations, if a prompt or other user interface element is displayed in conjunction with an image (or series of images) of a person speaking (e.g., facing toward and speaking) to the user, a vibration associated with a syllabic voice nasal consonant can be interpreted as an HMD control command.

As another specific example, an image (or series of images) indicating that a person is not speaking to the user (e.g., can confirm there is not an on-going conversation with another person) can be used to determine that a vibration associated with a syllabic voice nasal consonant is or is not an HMD control command directed to a prompt or other user interface element associated with an HMD.

In some implementations, when a conversation is detected with a person (separate from the user wearing an HMD) using one or more images (e.g., using image sensor 104), a voiced nasal consonant associated with (e.g., directly after the vocalized sentence) can be used to determine that the vibration is not an HMD control command, but is instead a communication directed to the person speaking to the user. In such situations, one or more vibrations associated with a voiced nasal consonant can be interpreted as being associated with a conversation and can be filtered out as not being an HMD control command.

In some implementations, a conversation with a person in a video conference can be detected using one or more images. In such situations, one or more vibrations associated with a voiced nasal consonant can be interpreted as being associated with a conversation and can be filtered out as not being an HMD control command.

As yet another example, a voiced nasal consonant and additional movements captured during or during a timeframe of detection of the voiced nasal consonant can be used to confirm the voiced nasal consonant as an HMD control command. For example, a movement of a head of a user (e.g., lower frequency than a vibration associated with a voiced nasal consonant) can be detected via the IMU 110 (or a separate movement measurement device) before a vibration (e.g., within a threshold period of time before the vibration), after a vibration (e.g., within a threshold period of time before the vibration), or during a vibration. In some implementations, the vibration can be accompanied by the movement, produced by the user wearing the HMD, that can be used to determine that the vibration is a voiced nasal consonant. In some implementations, the context, or content, of the movement of the user can be used to confirm that the voiced nasal consonant by the user is or is not an HMD control command. In some implementations, the vibration can be accompanied by a sound, produced by the user wearing the HMD, that can be further (in addition to the movement) used to determine whether the vibration is a voiced nasal consonant.

As a specific example, a head nod of a user (e.g., a user movement) can be used to confirm that a vibration associated with a syllabic voice nasal consonant is an HMD control command. If the head nod of the user is an up-and-down motion, that head nod in conjunction with the voiced nasal consonant can be used to determine that the voiced nasal consonant is a confirmatory (e.g., a “yes”) response.

As yet another example, a voiced nasal consonant during or after a prompt (e.g., a user interface prompt projected within a display of an HMD (e.g., HMD 112)) can be used to confirm the voiced nasal consonant as an HMD control command. For example, a prompt can be produced at an HMD during a vibration. In other words, the prompt can be accompanied by a vibration, produced by the user wearing the HMD, that can be used to determine whether the vibration is a voiced nasal consonant. The context, or content, of the prompt can be used to confirm that the voiced nasal consonant by the user is or is not an HMD control command.

As a specific example, a prompt followed by a vibration associated with a syllabic voice nasal consonant produced by a user can be interpreted as an HMD control command (e.g., a selection, a deletion, a confirmation, a negative response) directed to the HMD in response to a prompt.

As a specific example, a vibration associated with a syllabic voice nasal consonant produced by a user, without a prompt (e.g., the absence of a user interface prompt projected within a display of an HMD), can be interpreted as not being an HMD control command (e.g., a selection, a deletion, a confirmation, a negative response).

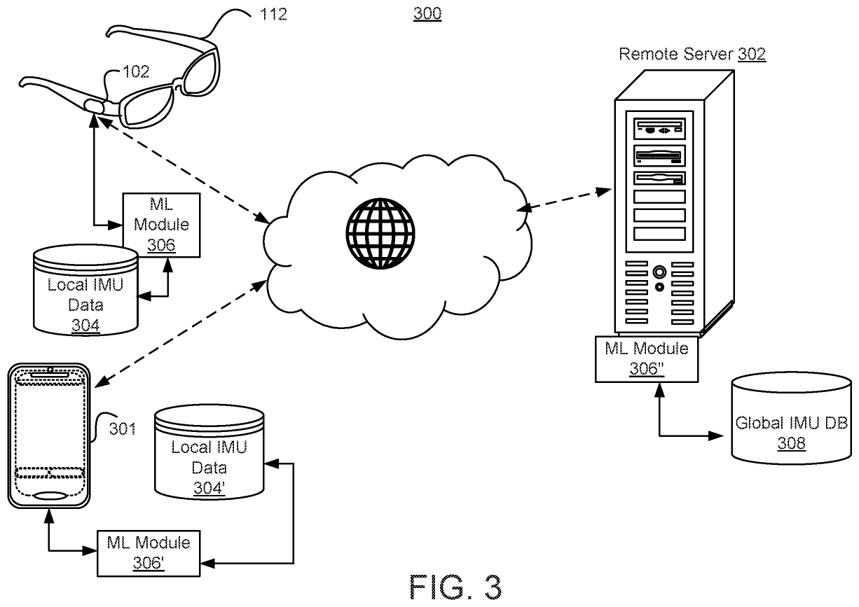

In this implementation shown in FIG. 2A, the ML module 206 is included in an HMD controller 102. In some implementations, the ML module 206 may be executed and/or included in a different location. Such additional implementations are described in connection with at least FIG. 3.

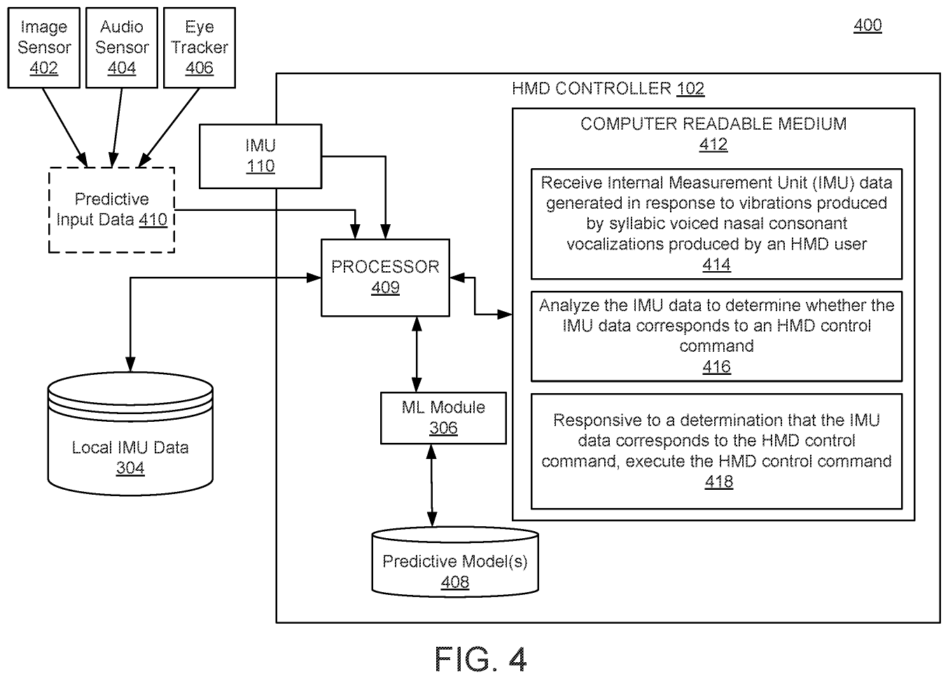

Additional examples of the use or predictive input data 24 are set forth in connection with at least FIG. 4. The examples associated with FIG. 4 can be processed using the architecture described here in connection with FIG. 2A.

The ML module 206 shown in FIG. 2A can execute one or more ML models to process the IMU data 22 and the predictive input data 24. In some implementations, any of the ML models described herein can be referred to as an ML classifier (e.g., ML prediction).

For example, in some implementations, an ML model can be used to process (e.g., classify, predict) both the IMU data 22 and one or more of the types of the predictive input data 24. In such implementations, the ML model can be trained on both the IMU data 22 and the one or more of the types of the predictive input data 24. As another example, in some implementations, an IMU ML model can be used to process (e.g., classify) the IMU data 22. In such implementations, a predictive input ML model (and/or portions thereof) can be used to process (e.g., classify) one or more of the types of the predictive input data 24. As shown in FIG. 2B, an IMU ML model 206-0 can be used to process (e.g., classify) the IMU data 22. Also, as shown in FIG. 2B, audio data 24-1 can be processed (e.g., classified) by an audio ML model 206-1, image data 24-2 can be processed by an image ML model 206-2, and eye tracking data 24-3 can be processed by an eye tracking ML model 206-3. Each of the ML models can be trained on the data corresponding with the ML model (e.g., audio ML model 206-1 can be trained based on audio data).

In some implementations, one or more of the ML data types and/or ML models may be excluded. For example, the system can exclude the image portion (e.g., image sensor 104, image data 24-2, image ML model 206-2) and/or the eye portion (e.g., eye tracker 105, eye tracking data 24-3, eye tracking ML model 206-3). In some implementations, the IMU portion (e.g., IMU 110, IMU data 22, and IMU ML model 206-0) may not be optional. In some implementations, the audio portion (e.g., audio sensor 103, audio data 24-1, and audio ML model 206-1) may not be optional.

The HMD controller 102 can be configured to combine the classified data using one or more rules or heuristics. Each of the ML models may be used to produce classified data corresponding to the model. For example, IMU classified data produced by the IMU ML model 206-0, audio classified data produced by the audio ML model 206-1, image classified data produced by the image ML model 206-2, and/or eye tracking classified data produced by the eye tracking ML model 206-3 may be combined using one or more rules to determine whether a vibration associated with voiced nasal consonant is, or is associated with, an HMD control command.

FIG. 2C illustrates an example implementation of the architecture shown and described in FIGS. 2A and/or 2B. Specifically, diagram 201 is configured to process a combination of low-level spectrograms of micro-voice gestures, in accordance with the disclosed implementations. The processing pipeline shown in FIG. 2B can be processed by the elements shown in, for example, FIG. 1.

In this example, the IMU 110 may employ a 3-channel accelerometer that provides raw IMU data (which can be a type of IMU data 22 shown in FIGS. 2A and/or 2B) to the HMD controller 102 (FIG. 1). The HMD controller 102 may perform per-channel gravity deletion on the raw IMU data at module 210 to compensate for the influence of gravity in order to get accurate measurements. Then, the HMD controller 102 may perform IMU data spectrogram extraction on data output by the module 210 at module 212. The raw IMU data may be converted into a digital format by a processor of the HMD controller 102 prior to being processed through the modules 210 and 212. Then, the extracted spectrogram data may be provided to a machine learning (ML) module 206 executing a model for determination of an HMD control command corresponding to the spectrogram data representing the user's micro-voice gestures (e.g., Mm-hmm, Hmm, etc.).

In some implementations, less than 3-channels of accelerometer data may be used from the IMU 110. In some implementations, a stream of accelerometer data may be analyzed to detect vibrations (e.g., vibrations in a frequency range) that could correspond with voiced nasal consonants.

In one implementation, an audio sensor such as a microphone array 204 (e.g., N-channel microphone array) (which can be a type of audio sensor 103 shown in FIG. 1) may be used to provide raw audio data to the HMD controller 102 which performs audio spectrogram extraction from the raw audio data (which can be a type of predictive input data 24 shown in FIGS. 2A and/or 2B) at module 214. The microphone array 204 may be used for detection of audio data of various intensities coming from multiple directions. Then, the extracted audio spectrogram data may be also processed by the HMD controller 102 and provided to the machine learning (ML) module 206 for contextual analysis of the audio spectrogram data to determine a presence of a distinct separate micro-voice gesture (i.e., a voiced nasal consonant) within the audio spectrogram data.

In some implementations, the spectrogram (both audio and accelerometer) can include information about the frequencies, changes over time, etc. The spectrogram extraction can include analyzing the IMU data and/or audio data for feature embeddings (e.g., patterns, data) that can be used in the ML module 206. The spectrogram extraction can be used to extract feature embeddings from a spectrogram as shown in, for example, FIG. 2D.

FIG. 2D illustrates an example spectrogram 280. Specifically, FIG. 2D illustrates a log-mel spectrogram. FIG. 2D illustrates frequency data (in Hertz (Hz)) on the Y axis and time (in seconds) on the X axis. The sound intensity in decibels (dB) is illustrated within this spectrogram 280 by a shading level. IMU data associated with voiced nasal consonants, because it is time dependent data, can be represented as a spectrogram such as the spectrogram 280 as illustrated in FIG. 2D. In some implementations, feature embeddings (e.g., one or more data points) from the spectrogram 280 are extracted and used for ML classification. More details about how these spectrograms (and feature embeddings from the spectrograms) are processed within an ML model are described in connection with at least FIGS. 2E and 2F.

Referring back to FIG. 2C, in some implementations, the IMU data from the IMU 110 and/or the audio data from the microphone array 204 can be processed using an ML model. The ML model can process (e.g., classify) the IMU data and the audio data in a combined fashion with a model trained on both the IMU data and the audio data.

In some implementations, as described above, the IMU data from the IMU 110 can be processed using an image ML model (e.g., IMU ML model 206-0 shown in FIG. 2B) at the ML module 206. Also as described above, the audio data from the microphone array 204 can be processed using an audio ML model (e.g., audio ML model 206-1 shown in FIG. 2B) at the ML module 206.

For example, contextual analysis provided by the ML module 206 can include detecting the distinct separate micro-voice gesture if it is preceded and/or followed by a period of silence of a pre-set duration. In at least one implementation, the extracted accelerator spectrogram data output by the module 212 may be combined with the extracted audio spectrogram data output from the module 214 at a ML module 206. The combination of the extracted accelerator spectrogram data and the extracted audio spectrogram data may be used for increased prediction accuracy by generation of a combined feature vector to be processed through the ML module 206 for classification and determination of HMD control command(s) corresponding to the raw data received from the IMU 110 and from the microphone array 204. The ML module 206 may employ calibration using a prototype network or transfer learning.

An alternative way for classification of voiced nasal consonants, without using low-level spectrograms, is to leverage the vowel recognition algorithm and apply a Recursive Neural Network (RNN) or Hidden Markov Models (HMM) to the vowels recognized by the algorithm. More details about a ML technique for classifying data (e.g., IMU data) using spectrograms produced using the data are described in connection with FIGS. 2E and 2F.

FIG. 2E is a diagram that illustrates production of a set of class prototypes of IMU feature embeddings 256 (shown as A1 through A5) using a pre-trained IMU ML model 255. The class prototypes of IMU feature embeddings 256 are feature embeddings that have been classified to represent specific voiced nasal consonants (e.g., feature embeddings related to a class prototype representing the “Nuh-un” voiced nasal consonant). The class prototypes of IMU feature embeddings 256, once produced, can be used in a nearest-neighbor IMU classifier shown in FIG. 2E.

The IMU feature embeddings, consistent with the description above, can be extracted from a spectrogram that represents a voiced nasal consonant. Although FIGS. 2D and 2E are related to IMU feature embeddings, the ML model and training techniques shown in FIGS. 2D and 2E can be applied to any of the predictive input data (and corresponding) spectrograms (e.g., log-mel spectrograms) described above.

In this implementation, a training set of IMU feature embeddings 254 is used to produce the class prototypes of IMU feature embeddings 256 through the pre-trained IMU ML model 255. The training set of IMU feature embeddings 254 includes a combination of a library of IMU feature embeddings 252 (produced by many individuals) and a user IMU feature embeddings 251 (produced by recordings (e.g., pre-recordings) from a target user (e.g., a specific user)). The user IMU feature embeddings 251 can be extracted from a spectrogram produced based on pre-recorded IMU data from vibrations of voiced nasal consonants produced by an HMD user. In some implementations, ambient sounds 253 can be incorporated into the user IMU feature embeddings to make the class prototypes of IMU feature embeddings 256 more robust during classification against ambient noise. In some implementations, the class prototypes of IMU feature embeddings can be averaged feature embeddings.

In some implementations, the training set of IMU feature embeddings 254 includes a combination of a library of IMU feature embeddings 251 (produced by many individuals) and a user IMU feature embeddings 252 (produced by recordings (e.g., pre-recordings) from a target user (e.g., a specific user)) so that the training set of IMU feature embeddings 254 can be customized for the specific user. In other words, the pre-trained IMU ML model 255, in combination with the library of IMU feature embeddings 252 and the user IMU feature embeddings 251 can be used to customize the ML processing (e.g., classification) of voiced nasal consonants.

The pre-trained IMU ML model 255 can be trained (e.g., ML coefficient determined) using a known set of IMU feature embeddings (e.g., the library of IMU feature embeddings 252). In some implementations, the library of IMU feature embeddings 252 can be based on voiced nasal gestures produced by many users wearing an HMD (e.g., HMD 112 shown in FIG. 1). In some implementations, the user IMU feature embeddings 251 can be based on voiced nasal gestures produced by a user wearing an HMD (e.g., HMD 112 shown in FIG. 1). In some implementations, the class prototypes of IMU feature embeddings 256 can be produced without user IMU feature embeddings 251. As mentioned above, the user IMU feature embeddings 251 can be used to customize the class prototypes of IMU feature embeddings 256 for the specific user. If the class prototypes of IMU feature embeddings 256 are based on only the library of IMU feature embeddings 252 the class prototypes of IMU feature embeddings 256 will be more generalized to any user because the library of IMU feature embeddings 256 is based on data (e.g., vibrations) from many users.

FIG. 2F is a diagram that illustrates a nearest neighbor IMU classifier 258 configured to classify candidate IMU feature embeddings 257. In some implementations, the nearest neighbor IMU classifier 258 can be the ML model executed within the ML module 206 shown in, for example, FIGS. 2A through 2C. The candidate IMU feature embeddings 257 can be IMU feature embeddings extracted from an IMU spectrogram, that represents a voiced nasal consonant (e.g., a voiced nasal consonant produced in real-time by a user wearing an HMD), produced using accelerometer data from an IMU produced in response to vibrations from the voiced nasal consonant (e.g., the voiced nasal consonant produced in real-time by a user wearing an HMD).

In some implementations, the candidate IMU feature embeddings 257 are classified by identifying (e.g., finding, determining) which of the class prototypes of IMU feature embeddings (A1 through A5) is a best match to the candidate IMU feature embeddings 257. In some implementations, this can be done by calculating the Euclidean distance in the feature embedding space.

In some implementations, the result of the nearest neighbor classifier 258 is represented as prediction data 259. The prediction data 259 can include a confidence level that the candidate IMU feature embeddings 257 matches with one of the class prototypes of IMU feature embeddings 256. In other words, classification of the candidate IMU feature embeddings 257 can be used to produce the prediction data 259 (and/or a confidence level).

For example, the prediction data 259 can include a 90% confidence level that the candidate IMU feature embeddings 257 matches with the class prototype of IMU feature embeddings A2. In some implementations, the prediction data 259, which provides a prediction (e.g., a confidence level) of the candidate IMU feature embeddings 257 being associated with a particular voiced nasal consonant, can be used to determine an HMD control command. In other words, classification of the candidate IMU feature embeddings 257 can be used to determine a voiced nasal consonant and/or HMD control command.

In some implementations, a threshold can be established to filter out the candidate IMU feature embeddings 257. For example, if the candidate IMU feature embeddings 257 is beyond a threshold Euclidean distance from one of the class prototypes of IMU feature embeddings 256, the one of the class prototypes of IMU feature embeddings 256 can be eliminated as not being a match.

FIG. 3 illustrates an example network 300 including an HMD controlled by the micro-voice gestures, in accordance with the disclosed implementations. The underlying architecture of FIG. 3 can be based on any of the implementations described in FIGS. 1 through 2B.

As discussed above with respect to FIG. 1, the HMD 112 may be controlled by the micro-voice gesture(s) of a user. An HMD controller 102 may receive IMU data. The HMD controller 102 may provide the IMU data to a machine learning (ML) module 306 executing a model for determination of an HMD control command corresponding to the IMU data representing the user's micro-voice gestures. The ML module 306 may be executed by the HMD controller 102 and may use local IMU data 304. The local IMU data 304 may include pre-recorded micro-voice gestures of the user that can be used by the ML module 306 for determination of an HMD control command corresponding to the micro-voice gesture of the user.

In at least one implementation, the ML module 306′ may be executed on a mobile device 301 connected to the HMD 112 over a wireless network. In at least one implementation, the mobile device 301 may be connected to the HMD 112 over a wireless peer-to-peer connection (e.g., Bluetooth™). In this scenario, the ML module 306′ may access local IMU data 304′ stored on (e.g., residing on) the mobile device 301.

In yet another implementation, the ML module 306″ may be implemented on a remote server 302 connected to the mobile device 301 over a wireless network. This arrangement may allow for the ML module 306″ to use globally IMU data 308 (e.g., globally collected historic IMU data) for supervised machine learning. For example, a variety of voiced nasal consonant samples recorded by multiple HMD users may be aggregated by the remote server 302 and stored in the global IMU database 308. This way, if a voiced nasal consonant received by the HMD controller 102 is not recognized locally using the stored local IMU data 304 and 304′, the voiced nasal consonant may be compared with a larger pool of historic samples of IMU data corresponding to HMD control commands. The ML model may include calibration using a prototype network or transfer learning.

FIG. 4 illustrates an example system 400 for micro-voice gesture recognition including a detailed description of an HMD controller, in accordance with implementations described herein.

The HMD controller 102 may include additional components and that some of the components described herein may be removed and/or modified without departing from a scope of the HMD controller 102 disclosed herein. The HMD controller 102 may be a computing device and may include a processor 409, which may be a semiconductor-based microprocessor, a central processing unit (CPU), an application specific integrated circuit (ASIC), a field-programmable gate array (FPGA), and/or another hardware device. Although a processor 409 (e.g., single processor) is depicted, it should be understood that the HMD controller 102 may include multiple processors, multiple cores, or the like, without departing from the scope of the HMD controller 102.

The HMD controller 102 may also include a non-transitory computer readable medium 412 that may have stored thereon machine-readable instructions executable by the processor 409. Examples of the machine-readable instructions are shown as 614-618 and are further discussed below. Examples of the non-transitory computer readable medium 412 may include an electronic, magnetic, optical, or other physical storage device that contains or stores executable instructions. For example, the non-transitory computer readable medium 412 may be a Random Access Memory (RAM), an Electrically Erasable Programmable Read-Only Memory (EEPROM), a hard disk, an optical disc, or other type of storage device.

The processor 409 may execute the machine-readable instructions 414 to receive Internal Measurement Unit (IMU) data generated in response to vibrations produced by voiced nasal consonant vocalizations produced by an HMD user. The processor 409 may execute the machine-readable instructions 416 to analyze the IMU data to determine whether the IMU data corresponds to an HMD control command. The processor 409 may execute the machine-readable instructions 418 to, responsive to a determination that the IMU data corresponds to the HMD control command, execute the HMD control command.

The processor 409 may execute the ML module 306 configured to generate a predictive model 408 to determine HMD control commands corresponding to the data received from the IMU 110 and from the audio sensor 406.

The ML module 306 may also use predictive input data 410 that may include eye-on-screen detection data (also can be referred to as eye-gaze data) (e.g., eye-gaze data produced using the eye tracker 105 shown in FIG. 1) indicating whether or not the user is looking at a particular HMD UI control while generating a micro-voice gesture. In other words, if an HMD user is looking at a “select” button on a screen of the HMD and produces the voiced nasal consonant, it is very likely that the HMD user is attempting to trigger a “select” action.

The predictive input data 410 may also include visual data indicating whether or not the HMD user is touching (for a touch input) a portion of a frame (e.g., holding a finger on a frame) of the HMD while generating a micro-voice gesture. In other words, if the HMD user is interacting with the HMD and is producing the voiced nasal consonant, this voiced nasal consonant is likely to be intended for controlling the HMD.

The predictive input data 410 may also include visual data indicating whether or not the HMD user is shaking or nodding his head while generating a micro-voice gesture. In this scenario, it is more likely that the HMD user is producing voiced nasal consonant as a part of a conversation and is not intending to control the HMD at the moment.

The predictive input data 410 may also include HMD state data (i.e., on/off or wake sleep state). For example, if the HMD is in an “off” or “sleep” state, the user may be producing the voiced nasal consonant that may be less likely intended to control the HMD compared to the same being produced when the HMD is in “on” or “awake” state.

In one implementation the predictive data 410 may be combined with the IMU 110 data and with the audio sensor 404 data for training the predictive model(s) 408. In one implementation, one or more microphones on the HMD can detect when the HMD user is in a conversation with another person, and thus voiced nasal consonant(s) is not intended to control the display. An image sensor 402 may be employed to generate the predictive data 410.

Specific “wake up” gestures such as double tapping on the HMD or humming a tune may be used as additional predictive data.

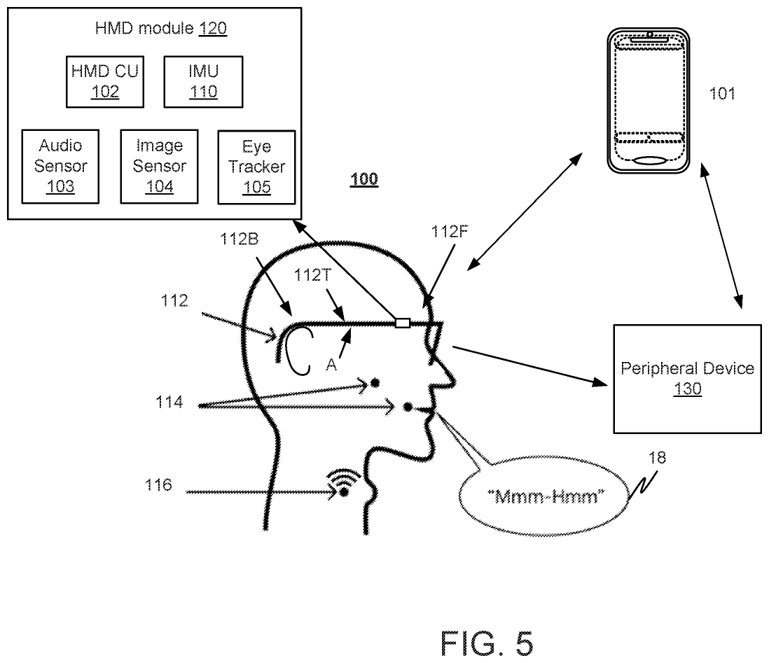

FIG. 5 is a diagram that illustrates control of a peripheral device 130 according to an implementation. As shown in FIG. 5, a voiced nasal consonant can be used to control the peripheral device 130. The peripheral device 130 can include a smart home device such as a thermostat, television, speaker and/or so forth. The peripheral device 130 may be connective, via network to the companion device 101 and/or the HMD 112.

For example, a prompt can be displayed within the HMD 112 related to the peripheral device 130. A vibration associated with a voiced nasal consonant can be used to respond to the prompt. Accordingly, the vibration associated with a voiced nasal consonant can be used to send an instruction to (e.g., control) the peripheral device 130.

As a specific example, a prompt to activate (or control in another way) the peripheral device 130 can be triggered for display within the HMD 112 by the companion device 101. A user can respond by making a “Mm-hm” syllabic voice nasal consonant. The vibration of the voiced nasal consonant can be interpreted as a positive response to the prompt using the HMD 112 and/or the companion device 101. The intent to turn on the peripheral device 130 using the voiced nasal consonant can be confirmed by the user looking toward the peripheral device 130 (using an outward facing image sensor) while looking at the prompt (as determined using an eye tracker 105). In response to this confirmation, the companion device 101 and/or the HMD 112 can send a signal to the peripheral device 130 to activate the peripheral device 130.

In some implementations, the peripheral device 130 can function as a companion device 101. In some implementations, the companion device 101 can be a peripheral device such as peripheral device 130 and can function in any of the ways described above.

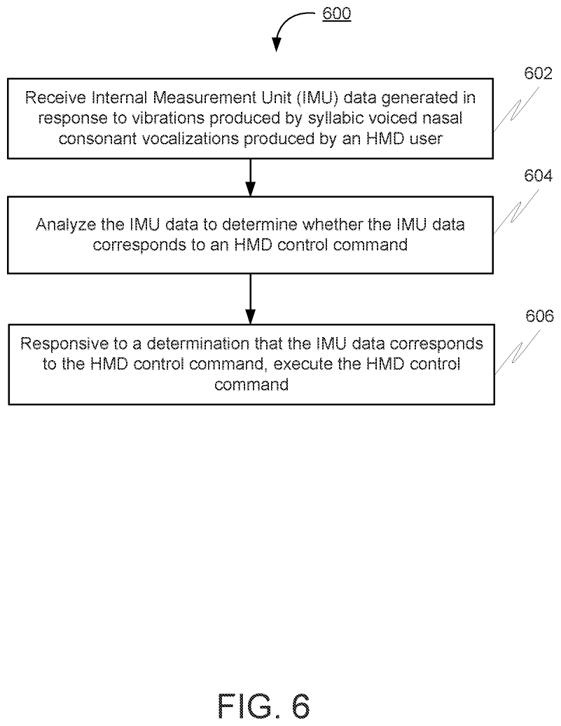

FIG. 6 is a flowchart of an example method 600 for micro-voice gesture recognition, in accordance with the disclosed implementations. Referring to FIG. 6, the method 600 may include one or more of the steps described below.

FIG. 6 illustrates a flow chart of an example method executed by the HMD controller 102 (see FIG. 4). It should be understood that method 600 depicted in FIG. 6 may include additional operations and that some of the operations described therein may be removed and/or modified without departing from the scope of the method 600. The description of the method 600 is also made with reference to the features depicted in FIG. 4 for purposes of illustration. Particularly, the processor 409 of the HMD controller 102 may execute some or all of the operations included in the method 600.

With reference to FIG. 6, at block 602, the processor 409 may receive inertial measurement unit (IMU) data generated in response to vibrations produced by voiced nasal consonant vocalizations produced by an HMD user. At block 604, the processor 409 may analyze the IMU data to determine whether the IMU data corresponds to an HMD control command. At block 606, the processor 409 may, responsive to a determination that the IMU data corresponds to the HMD control command, execute the HMD control command.

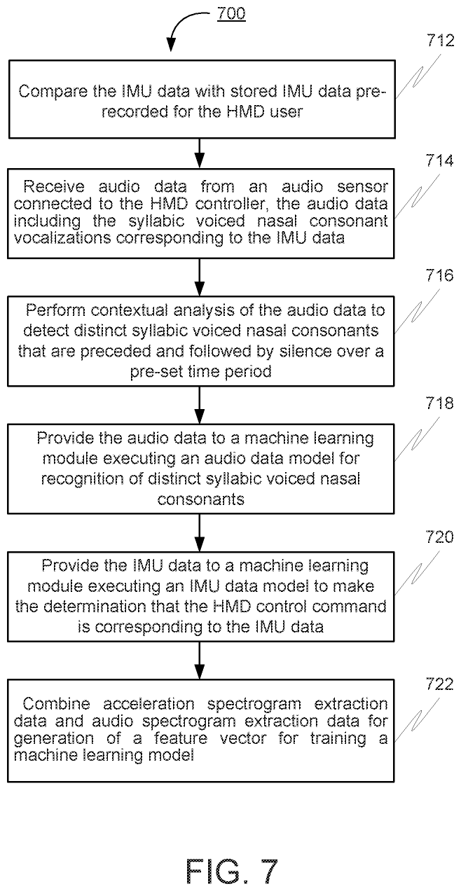

FIG. 7 illustrates a further flow diagram 700 of a method, according to the implementations of the disclosure. Referring to FIG. 7, the flow diagram 700 may also include one or more of the following steps. At block 712, the processor 409 may compare the IMU data with stored IMU data pre-recorded for the HMD user. At block 714, the processor 409 may receive audio data from an audio sensor connected to the HMD controller, the audio data may include the voiced nasal consonant vocalizations corresponding to the IMU data. At block 716, the processor 409 may perform contextual analysis of the audio data to detect distinct voiced nasal consonants that are preceded and followed by silence over a pre-set time period. At block 718, the processor 409 may provide the audio data to a machine learning module executing an audio data model for recognition of distinct voiced nasal consonants. At block 720, the processor 409 may provide the IMU data to a machine learning module executing an IMU data model to make the determination that the HMD control command is corresponding to the IMU data. At block 722, the processor 409 may combine acceleration spectrogram extraction data and audio spectrogram extraction data for generation of a feature vector for training a machine learning model.

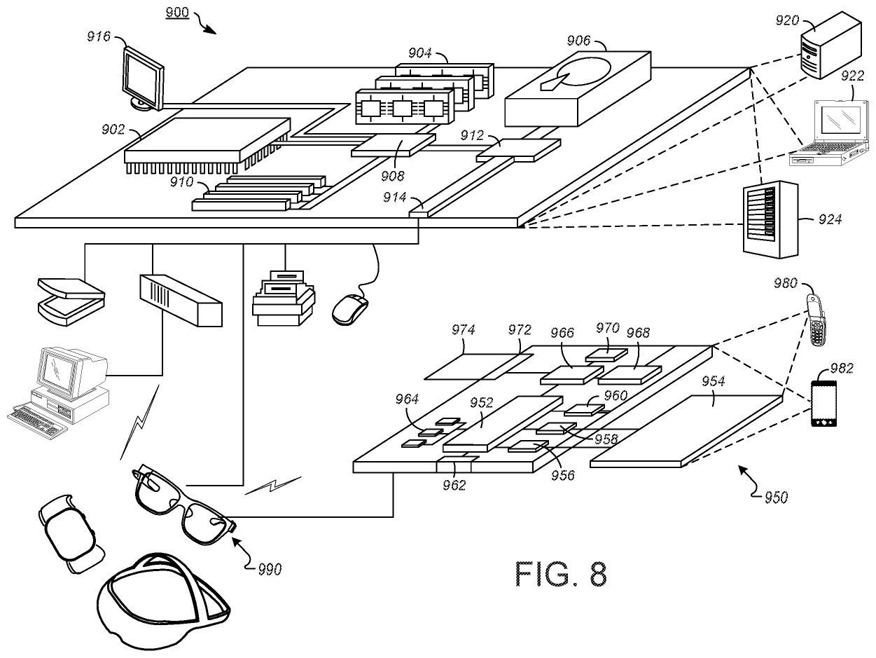

FIG. 8 shows an example of a generic computer device 900 and generic mobile computer devices 950, 990, which may be used with the techniques described herein. Computing device 900 is intended to represent various forms of digital computers, such as laptops, desktops, tablets, workstations, personal digital assistants, televisions, servers, blade servers, mainframes, and other appropriate computing devices. For example, computing device 900 may be and/or be used as the server referenced above. Computing device 950 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 900 includes a processor 902, memory 904, a storage device 907, a high-speed interface 908 connecting to memory 904 and high-speed expansion ports 910, and a low-speed interface 912 connecting to low-speed bus 914 and storage device 907. The processor 902 can be a semiconductor-based processor. The memory 904 can be a semiconductor-based memory. Each of the components 902, 904, 907, 908, 910, and 912, are interconnected using various busses, and may be mounted on a common motherboard or in other manners as appropriate. The processor 902 can process instructions for execution within the computing device 900, including instructions stored in the memory 904 or on the storage device 907 to display graphical information for a GUI on an external input/output device, such as display 917 coupled to high-speed interface 908. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 904 stores information within the computing device 900. In one implementation, the memory 904 is a volatile memory unit or units. In another implementation, the memory 904 is a non-volatile memory unit or units. The memory 904 may also be another form of computer-readable medium, such as a magnetic or optical disk.

The storage device 907 is capable of providing mass storage for the computing device 900. In one implementation, the storage device 907 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 904, the storage device 907, or memory on processor 902.

The high-speed controller 908 manages bandwidth-intensive operations for the computing device 900, while the low-speed controller 912 manages lower bandwidth-intensive operations. Such allocation of functions is exemplary only. In one implementation, the high-speed controller 908 is coupled to memory 904, display 917 (e.g., through a graphics processor or accelerator), and to high-speed expansion ports 910, which may accept various expansion cards (not shown). In the implementation, low-speed controller 912 is coupled to storage device 907 and low-speed expansion port 914. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 977, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as device 950. Each of such devices may contain one or more of computing device 900, 950, and an entire system may be made up of multiple computing devices 900, 950 communicating with each other.

Computing device 950 includes a processor 952, memory 974, an input/output device such as a display 954, a communication interface 977, and a transceiver 978, among other components. The device 950 may also be provided with a storage device, such as a micro-drive or other device, to provide additional storage. Each of the components 950, 952, 974, 954, 977, and 978, are interconnected using various buses, and several of the components may be mounted on a common motherboard or in other manners as appropriate.

The processor 952 can execute instructions within the computing device 950, including instructions stored in the memory 974. The processor may be implemented as a chipset of chips that include separate and multiple analog and digital processors. The processor may provide, for example, for coordination of the other components of the device 950, such as control of user interfaces, applications run by device 950, and wireless communication by device 950.

Processor 952 may communicate with a user through control interface 958 and display interface 957 coupled to a display 954. The display 954 may be, for example, a TFT LCD (Thin-Film-Transistor Liquid Crystal Display) or an OLED (Organic Light Emitting Diode) display, or other appropriate display technology. The display interface 957 may comprise appropriate circuitry for driving the display 954 to present graphical and other information to a user. The control interface 958 may receive commands from a user and convert them for submission to the processor 952. In addition, an external interface 972 may be provided in communication with processor 952, so as to enable near area communication of device 950 with other devices. External interface 972 may provide, for example, for wired communication in some implementations, or for wireless communication in other implementations, and multiple interfaces may also be used.

The memory 974 stores information within the computing device 950. The memory 974 can be implemented as one or more of a computer-readable medium or media, a volatile memory unit or units, or a non-volatile memory unit or units. Expansion memory 974 may also be provided and connected to device 950 through expansion interface 972, which may include, for example, a SIMM (Single In Line Memory Module) card interface. Such expansion memory 974 may provide extra storage space for device 950, or may also store applications or other information for device 950. Specifically, expansion memory 974 may include instructions to carry out or supplement the processes described above, and may include secure information also. Thus, for example, expansion memory 974 may be provided as a security module for device 950, and may be programmed with instructions that permit secure use of device 950. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 974, expansion memory 974, or memory on processor 952, that may be received, for example, over transceiver 978 or external interface 972.

Device 950 may communicate wirelessly through communication interface 977, which may include digital signal processing circuitry where necessary. Communication interface 977 may provide for communications under various modes or protocols, such as GSM voice calls, SMS, EMS, or MMS messaging, CDMA, TDMA, PDC, WCDMA, CDMA700, or GPRS, among others. Such communication may occur, for example, through radio-frequency transceiver 978. In addition, short-range communication may occur, such as using a Bluetooth, WiFi, or other such transceiver (not shown). In addition, GPS (Global Positioning System) receiver module 970 may provide additional navigation- and location-related wireless data to device 950, which may be used as appropriate by applications running on device 950.

Device 950 may also communicate audibly using audio codec 970, which may receive spoken information from a user and convert it to usable digital information. Audio codec 970 may likewise generate audible sound for a user, such as through a speaker, e.g., in a handset of device 950. Such sound may include sound from voice telephone calls, may include recorded sound (e.g., voice messages, music files, etc.) and may also include sound generated by applications operating on device 950.

The computing device 950 may be implemented in a number of different forms, as shown in the figure. For example, it may be implemented as a cellular telephone 980. It may also be implemented as part of a smartphone 982, personal digital assistant, or other similar mobile device.

Various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described herein can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described herein can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described herein), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems.

1. A computer-implemented method for controlling a head mounted device (HMD), the computer-implemented method comprising:
receiving, by an HMD controller, inertial measurement unit (IMU) data generated in response to a vibration produced by a voiced nasal consonant produced by an HMD user;
analyzing, by the HMD controller, the IMU data to determine whether the IMU data corresponds to an HMD control command; and
responsive to a determination that the IMU data corresponds to the HMD control command, sending an instruction corresponding with the HMD control command.

2. The computer-implemented method of claim 1, wherein analyzing the IMU data further comprising comparing feature embeddings from a IMU spectrogram representing the IMU data with a class prototype of IMU feature embeddings, the class prototype of IMU feature embeddings being produced based on pre-recorded IMU data for the HMD user.

3. The computer-implemented method of claim 1, further comprising receiving audio data from an audio sensor connected to the HMD controller, the audio data including the voiced nasal consonant corresponding to the IMU data.

4. The computer-implemented method of claim 3, further comprising performing analysis of the audio data to confirm that the voiced nasal consonant corresponds to the HMD control command.

5. The computer-implemented method of claim 3, further comprising providing the audio data to a machine learning module executing an audio data ML model for recognition of the voiced nasal consonant.

6. The computer-implemented method according to claim 1, further comprising providing the IMU data to a machine learning module executing an IMU data ML model to make the determination that the voiced nasal consonant corresponds to the HMD control command.

7. The computer-implemented method of claim 1, wherein analyzing the IMU data further comprising:
extracting feature embeddings from an IMU spectrogram representing the IMU data;
classifying the feature embeddings from the IMU spectrogram using an IMU classifier as a class prototype of IMU feature embeddings; and
determining the HMD control command based on the class prototype of the IMU feature embeddings.

8. The computer-implemented method of claim 7, wherein the class prototype of the IMU feature embedding corresponds with the voiced nasal consonant.

9. The computer-implemented method of claim 7, wherein the classifying includes calculating a confidence level.

10. The computer-implemented method of claim 7, wherein the classifying includes calculating prediction data.

11. The computer-implemented method of claim 1, further comprising combining the IMU data with predictive input data including user eye-gaze data.

12. The computer-implemented method of claim 1, further comprising combining the IMU data with predictive input data comprising detection of a touch input on a frame of the HMD.

13. The computer-implemented method of claim 1, further comprising combining the IMU data with predictive input data including a user movement.

14. The computer-implemented method of claim 1, further comprising combining the IMU data with predictive input data including image sensor data.

15. A system for controlling a head mounted device (HMD) comprising: a processor of an HMD controller connected to an inertial measurement unit (IMU); and
a memory on which are stored machine-readable instructions that when executed by the processor, cause the processor to:
receive Internal Measurement Unit (IMU) data generated in response to a vibration produced by a voiced nasal consonant produced by an HMD user;
analyze the IMU data to determine whether the IMU data corresponds to an HMD control command; and
responsive to a determination that the IMU data corresponds to the HMD control command, sending an instruction corresponding with the HMD control command.

16. The system of claim 15, wherein the machine-readable instructions further cause the processor to compare the IMU data with stored IMU data pre-recorded for the HMD user.

17. The system of claim 15, wherein the machine-readable instructions further cause the processor to receive audio data from an audio sensor connected to the HMD controller, the audio data including the voiced nasal consonant corresponding to the IMU data.

18. The system of claim 17, wherein the machine-readable instructions further cause the processor to perform contextual analysis of the audio data to confirm that the voiced nasal consonant corresponds to the HMD control command.

19. The system of claim 17, wherein the machine-readable instructions further cause the processor to provide the audio data to a machine learning module executing an audio data model for recognition of the voiced nasal consonant.

20. The system of claim 15, wherein the machine-readable instructions further cause the processor to provide the IMU data to a machine learning module executing an IMU data model to make the determination that the voiced nasal consonant corresponds to the HMD control command.

21. A non-transitory computer-readable medium storing instructions that, when executed by a processor of cause the processor to perform a method comprising:
receiving inertial measurement unit (IMU) data generated in response to a vibration produced by a voiced nasal consonant produced by an HMD user;
analyzing the IMU data to determine whether the IMU data corresponds to an HMD control command; and
responsive to a determination that the IMU data corresponds to the HMD control command, sending an instruction corresponding with the HMD control command.

22. The non-transitory computer-readable medium of claim 21, further comprising comparing the IMU data with stored IMU data pre-recorded for the HMD user.

23. The non-transitory computer-readable medium of claim 21, further comprising providing the IMU data to a machine learning module executing an IMU data model to make the determination that the voiced nasal consonant corresponds to the HMD control command.
